(19) United States
(12) Patent Application Publication
(10) Pub. No.: US 2019/0121631 A1
(43) Pub. Date: Apr. 25, 2019

(54) DEPLOYMENT OF APPLICATIONS TO MANAGED DEVICES

(71) Applicant: VMWARE, INC., Palo Alto, CA (US)

(72) Inventors: XUELIANG HUA, Atlanta, GA (US); CRAIG NEWELL, Atlanta, GA (US); AZHAR FAIZ SAMDANI, Bangalore (IN); SEEMA KADAVAN, Bangalore (IN); PAVAN GONAGUR, Bangalore (IN)

(21) Appl. No.: 15/889,239

(22) Filed: Feb. 6, 2018

(30) Foreign Application Priority Data
Oct. 19, 2017 (IN) 201741037138

(51) Int. Cl. G06F 8/61; H04L 29/08

(52) U.S. Cl. CPC G06F 8/63; H04L 67/28; H04L 67/34

(57) ABSTRACT

Disclosed are examples of deploying application to devices that are enrolled as managed devices with a management service. An application package is deployed to a management component on a client device. The management component causes the application package to be installed by an application installation client that is installed on the client device and that is a separate application from the management component.

### RELATED APPLICATIONS

Benefit is claimed under 35 U.S.C. 119(a)-(d) to Foreign Application Serial No. 201741037138 filed in India entitled “DEPLOYMENT OF APPLICATIONS TO MANAGED DEVICES”, on Oct. 19, 2017, by VMware, Inc., which is herein incorporated in its entirety by reference for all purposes.

### BACKGROUND

Computing devices that execute Apple's macOS® operating system can be enrolled as managed devices, or client devices, with a remotely executed management service. Enrollment as a managed device allows an enterprise to install enterprise related applications on the client device. In some device management frameworks, deploying macOS applications onto a macOS device can be cumbersome and difficult for an enterprise administrator. Some tools that facilitate remote installation of applications onto macOS devices allow applications to be remotely deployed to a macOS device, but these tools are not integrated into device management frameworks.

Additionally, information about the status of a remotely installed application can be important for an administrator of a managed device. Certain tools that facilitate remote installation of macOS applications might provide limited installation status information to an administrator. Additionally, in an enterprise environment, an administrator likely has to manage various devices that use different operating systems. For example, the administrator can be faced with managing Windows® and macOS client devices. Therefore, a unified portal that allows macOS and Windows applications to be deployed might be desired by the administrator.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram depicting an example of a network environment.

FIG. 2 is a schematic block diagram depicting an example of a network environments.

FIG. 3 is a schematic block diagram depicting an example of a network environment.

FIG. 4 is a flowchart depicting one example of a portion of the functionality of the present disclosure.

### DETAILED DESCRIPTION

Disclosed are various examples for streamlining and automating the deployment of applications by a management service to a client device that is enrolled with the management service as a managed device. In particular, examples of this disclosure are related to systems and methods that can deploy application binaries or application packages to devices that are running an Apple macOS® operating system, such as macOS X and other variants of operating systems that are compatible with these devices. These operating systems are referred to herein as macOS collectively. In an enterprise environment, devices are often enrolled as managed devices with a management service that can be tasked with managing Windows® devices, macOS devices, mobile devices, or other devices that might be running another operating system. Deploying applications to devices that are running different operating systems can be a cumbersome or time-consuming process for an enterprise administrator.

The different operating systems can require different workflows to deploy applications to managed devices. In this context, deploying an application means causing a client device to obtain and install an application as directed by a management service. For example, a macOS application can be packaged in various ways that are different from a Windows application. An Android™ application can be packaged different from an iOS® application, and so on.

Some open source tools can be used to deploy applications to macOS devices. For example, Munki is as application deployment framework that includes a client that is installed on a macOS device and a server that can operated by an administrator to deploy applications to macOS devices. However, tools such as these typically do not incorporate device management features that allow an administrator to manage the device in other ways required by an enterprise. Additionally, the security model of tools such as these may not comply with the security requirements of an enterprise. Therefore, examples of this disclosure allow an administrator of an enterprise service to a use a single, unified console to deploy applications to managed devices in a management service that integrates holistic device management capabilities and data security capabilities. In the following discussion, a general description of the system and its components is provided, followed by a discussion of the operation of the same.

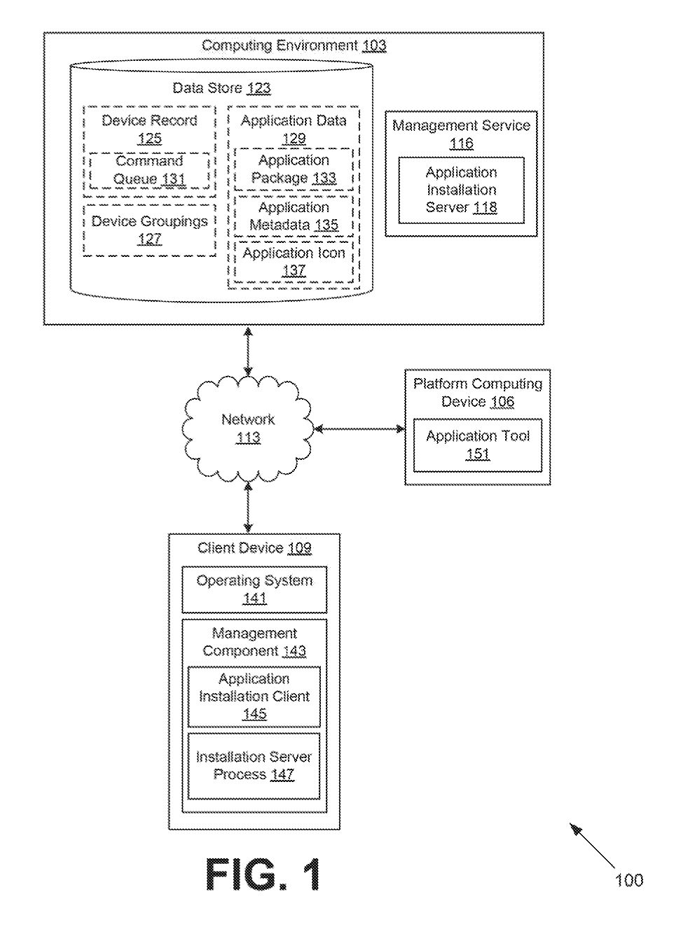

Beginning with FIG. 1, shown is an example of a networked environment 100. The networked environment 100 includes a computing environment 103, a platform computing device 106, and a client device 109, which are in data communication with each other via a network 113. The network 113 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include, for example, a server computer or any other system providing computing capability. Alternatively, the computing environment 103 can employ a plurality of computing devices that can be arranged, for example, in one or more server banks or computer banks or other arrangements. The computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time. In some instances, the computing environment 103 can be hosted within the same computing environment or be separate logical components of the same computing environment. This could occur, for example, if the computing environment 103 corresponded to one or more virtualized computing devices hosted by the same provider or in the same datacenter.

Various applications or other functionality can be executed in the computing environment 103 according to various embodiments. The components executed on the computing environment 103, for example, can include a management service 116, and other applications, services, processes, systems, engines, or functionality not discussed in detail herein. The management service 116 can administer the operation of various client devices 109 registered or otherwise enrolled with the management service 116 as managed devices. To this end, the management service 116 can track which applications have been installed on individual client devices 109 or groupings of client devices 109 and which applications have been selected or approved for installation on individual client devices 109 or groupings of client devices 109, as well as enforce requirements that particular applications be installed to (or uninstalled from) various client devices 109.

For example, the management service 116 can enforce various enterprise compliance rules on a managed client device 109. Compliance rules can include, for example, configurable criteria that must be satisfied for an enrolled one of the client devices 109 to be “in compliance” with the management service 116. The compliance rules can be based on a number of factors including geographical location of the client device 109, activation status, enrollment status, authentication data including authentication data obtained by a device registration system, time, and date, and network properties, among other factors. The compliance rules can also be determined based on a user profile associated with a user. The user profile can be identified by obtaining authentication data associated with the client device 109. The user profile can be associated with compliance rules that are further determined based on time, date, geographical location and network properties detected by the client device 109. The user profile can further be associated with a user group, and compliance rules can be determined in view of the user group.

Compliance rules can include predefined constraints that must be met in order for the management service 116, or other applications, to permit access to the enterprise data or other features of the client device 109. In some examples, the management service 11 communicates with a management component, an enrollment application, or application or service on the client device 109 to determine whether states exist on the client device 109 that do not satisfy one or more compliance rules. Some of these states can include, for example, a virus or malware being detected on the client device 109, installation or execution of a blacklisted application, or a client device 109 being “rooted” or “jailbroken,” where root access is provided to a user of the client device 109. Additional states can include the presence of particular files, questionable device configurations, vulnerable versions of client applications, or other vulnerability, as can be appreciated.

The application installation server 118 can represent a module or functionality of the management service 116. The application installation server 118 can transmit commands to a client device 109 to install a specified application binary using particular configuration settings or configuration commands. In some cases, the application installation server 118 can transmit an application package for installation on a managed client device 109 along with a command or instructions for the client device 109 to install or configure the application.

Also, various data is stored in a data store 123 that is accessible to the computing environment 103. The data store 123 can be representative of a plurality of data stores, which can include relational databases, object-oriented databases, hierarchical databases, hash tables or similar key-value data stores, as well as other data storage applications or data structures. The data stored in the data store 123 is associated with the operation of the management service 116 and potentially other applications or functional entities described herein. This data can include device records 125, device groupings 127, application data 129, and potentially other data. In some cases, the data store 123 can also include information about users of the enterprise. In other scenarios, user data can be housed in and retrieved from a directory service associated with the enterprise. The directory service can use MICROSOFT® Active Directory, Lightweight Directory Access Protocol (LDAP), VMWARE® Socialcast, VMWARE® Identity Manager (vIDM), and other directory services. The directory can be maintained separately from the management service 116 in some implementations.

For example, user accounts can be associated with devices that are enrolled as managed devices with the management service 116. User accounts can be associated with a particular device record 125 so that the user account is linked with a particular managed device. In one scenario, a user can enroll a client device 109 with the management service 116 by providing his or her credentials to a management component on the client device 109. Upon authenticating the user with the management service 116, the management service 116 can remotely manage the client device by communicating with the management component, which can act as an agent on the client device 109 that applies rules, policies, or performs other actions on the client device 109 on behalf of the management service 116. To this end, a device record 125 can identify a user associated with the device using a user identifier.

A device record 125 can also include a device identifier, such as a unique device identifier (UDID), which identifies a particular client device 109 that is enrolled as a managed device. The device identifiers can include serial number, a hardware identification number, a media access control (MAC) address or International Mobile Equipment Identity (IMEI) number of a network card installed on the client device 109, or other attribute that uniquely identifies a client device 109 from other client devices 109 managed by the management service 116. The device record 125, in some implementations, can identify one or more applications that are assigned to a corresponding client device 109.

The device record 125 can also specify certain compliance rules, policies, configuration profiles, or other data that should be stored on or enforced on the client device 109. For example, the device record 125 can specify location based restrictions, forbidden applications, or other rules or restrictions that the management service 116 can enforce upon a managed device.

To this end, the device record 125 can include a command queue 131 that, is associated with a corresponding client device 109. The command queue 131 can store one or more commands that the management component can perform on a client device 109. The management component can periodically query the command queue 131 to determine whether the management service 116 has instructed the management component to take any actions upon, a client device 109. In some examples, a push notification can be, sent to the client, device 109 that causes the client device 109 to query its command queue 131. In some examples, rather than maintaining a command queue 131 in the data store 123, commands from the management service 116 can be pushed or otherwise transmitted to the client device 109.

In one example, the management service 116 can place a command in a command queue 131 associated with a client device 109 that, when retrieved and executed by the client device 109 causes the client device 109 to download a particular application and install it upon the client device 109 using specified configuration settings.

In addition, the device record 125 can include an enrollment status indicating whether a client device 109 is enrolled with the management service 116. In one example, a client device 109 designated as “enrolled” can be permitted to access enterprise data while a client device 109 designated as “not enrolled,” or having no designation, can be denied access to the enterprise data.

Additionally, a device record 125 can include indications of the state of the client device 109. In one example, these indications can specify applications that are installed on the client device 109, configurations or settings that are applied to the client device 109, user accounts associated with the client device 109, the physical location of the client device 109, the network to which the client device 109 is connected, and other information describing the current state of the client device 109.

Further, device record 125 can also include data pertaining to user groups or device groupings 127. An administrator can specify one or more of the client devices 109 as belonging to an assignment group or grouping. An assignment group represents a group of devices that are grouped by a specified criteria. Client devices 109 can also be grouped into user groups. The management service 116 can enroll a client device 109 as belonging to a particular user group. User groups can be created by an administrator of the management service 116 so that a batch of client devices 109 can be configured according to common settings. For instance, an enterprise can create a user group for the marketing department and the sales department, where the client devices 109 in the marketing department are configured differently from the client devices 109 in the sales department.

Device groupings 127 can represent groups of devices that are managed by the management service 116. Devices can be grouped according to various parameters that are accessible to the management service 116. For example, devices that are assigned to users in a particular geographic location, job function, role, or demographic category can be grouped together into a device grouping 127. In some examples, an administrator can assign an application to a set of client devices 109 by assigning the application to a particular device grouping 127. In response to an application getting assigned to a device grouping 127, the management service 116 can cause the application to be deployed to the client devices 109 that are members of the device grouping 127.

Application data 129 can store information about applications that the management service 116 can deploy to client devices 109. Application data 129 can include an application package 133. The application package 133 can include an application binary or installer that can be executed on the client device 109. In a macOS environment, the application package 133 can be a disk image file (.dmg), a package file (.pkg), a package of package files, an Apple package file, or other formats that are used to distribute and install applications on a macOS device. In some examples, the application data can include an application identifier, which represents a serial number, name, hash, or other identifier of an application that uniquely identifies the application with respect to other applications stored within the application data 129.

Application metadata 135 can include information about an application associated with deployment of the application. For example, application metadata 135 can specify how files associated with the application should be stored when an application is installed on a client device 109. The application metadata 135 can also specify information necessary for the application to launch or function properly. For example, the application metadata 135 can specify authentication credentials or server addresses that are necessary for the application to authenticate itself to a remote server. The application metadata 135 can specify other configuration parameters that an installer executed on the client device 109 can access to properly install and configure an installation of the application.

The application metadata 135 can also include pre-installation or post-installation scripts or applications that should be executed to properly install or configure an application on a client device 109. Along with pre-installation and post-installation scripts, scripts, commands or programs to install the application itself can also be executed. In addition, the application metadata 135 can specify pre-requisite applications or conditions tier installation of a particular application. Configuration options and instructions can be provided by an administrator through an administrative console user interface or via editing of the application metadata 135 and associated with an application package 133 as application metadata 135.

The application icon 137 can represent a graphical icon that is associated with an application. The application icon 137 can be extracted from the application package 133 and used in one or more administrative console user interfaces that are generated by the management service 116 for an administrator. The administrative console user interfaces can allow an administrator to administer the management service 116 on behalf of an enterprise. The application icon 137 can also be displayed on the client device 109 within a client application for an application catalog or marketplace.

The client device 109 is representative of a plurality of client devices that can be coupled to the network 113. The client device 109 can include, for example, a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc [DVD] players, set-top boxes, and similar devices), a videogame console, or other devices with like capability. The client device 109 can include one or more displays, such as liquid crystal displays (LCDs), gas plasma-based flat panel displays, organic light emitting diode (OLED) displays, electrophoretic ink (“E-ink”) displays, projectors, or other types of display devices.

The client device 109 can execute an operating system 141 that manages the operation of the client device 109. The operating system 141 can have application programming interfaces (API's) that facilitate management of the device by the management service 116. In examples of this disclosure, the operating system 141 can be Apple macOS, as the application installation server 118 can facilitate installation of application packages 133 onto a macOS device.

The client device 109 can execute a management component 143. The management component 143 can be an application or service that can communicate with the management service 116 to administer the client device 109. The management component 143 can be installed with elevated or administrative privileges and enforce compliance rules, install configuration profiles or policies, or perform other actions to administer the client device 109 on behalf of the management service 116 in the context of this disclosure, the management component 143 can facilitate the installation of application packages 133 on the client device 109 on behalf of the management service 116.

The application installation client 145 can be an application or service that is executed on the client device 109 to perform the installation of application packages 133 on the client device 109 on behalf of the management component 143. In one implementation, the application installation client 145 can be the Munki client, which is a managed software installation client that works in conjunction with a Munki server. In examples of this disclosure, the management component 143 can work in tandem with the Munki client cause application to be installed on the client device 109. By employing a client such as Munki, the management component 143 can cause the application installation client 145 to install applications on the client device 109 using an application that is separate from the management component 143. In some implementations, application installation client 145 can be packaged as a component or module of the management component 143.

The installation server process 14 can be a server process that is executed as a module of or separate from the management component 143. The installation server process 147 can implement the functionality of a server that the application installation client 145 communicates with to deploy applications onto the client device 109. In this way, rather than the Munki server that corresponds to the Munki client being implemented on different machines, the Munki server and Munki client can both be implemented on the client device 109. The installation server process 147 can operate as a proxy server through which the Munki client can obtain application packages, binaries, scripts, or other files needed to deploy, and install a particular application onto the client device 109.

For example, the installation server process 147 allow the Munki client to access application packages and other files needed to complete the installation of an application that might be stored in a remote location that is otherwise inaccessible to the application installation client 145. Additionally, the installation server process 147 can allow the application installation client 145 to access external networks without nodes on the external network being able to access the application installation client 145. In this way, the risk of a node outside of the client device 109 from communicating with the application installation client 145 and causing it to install or uninstall a particular application is minimized.

The platform computing device 106 represents a device that can be utilized in conjunction with the management service 116 to extract various files from an application package 133, such as the application metadata 135 and an application icon 137. In some implementations, the platform computing device 106 can extract an application installer, application binary, or other files from the application package 133.

In implementations of this example, the platform computing device 106 can execute an application tool 151. The application tool 151 can be a program or utility that is executed by the administrator to extract the application metadata 135, application icon 137, and other configuration information about an application from a provided application package 133. The extracted data can be provided by the application tool 151 to the management service 116, which can store the data in the data store 123 so that the management service 116 can deploy application packages 133 to the client device 109.

The platform computing device 106 can be a macOS device so that it has the capability to parse an application package 133 and extract the application binary, installers, or other data from the application package 133 that is stored in the data store 123. The reason a platform computing device 106 executing the application tool 151 is utilized is because the computing environment 103 can sometimes execute a different operating system than a client device 109 that it manages. As a result, an off-the-shelf application tool 151 may not be compatible with the computing environment 103.

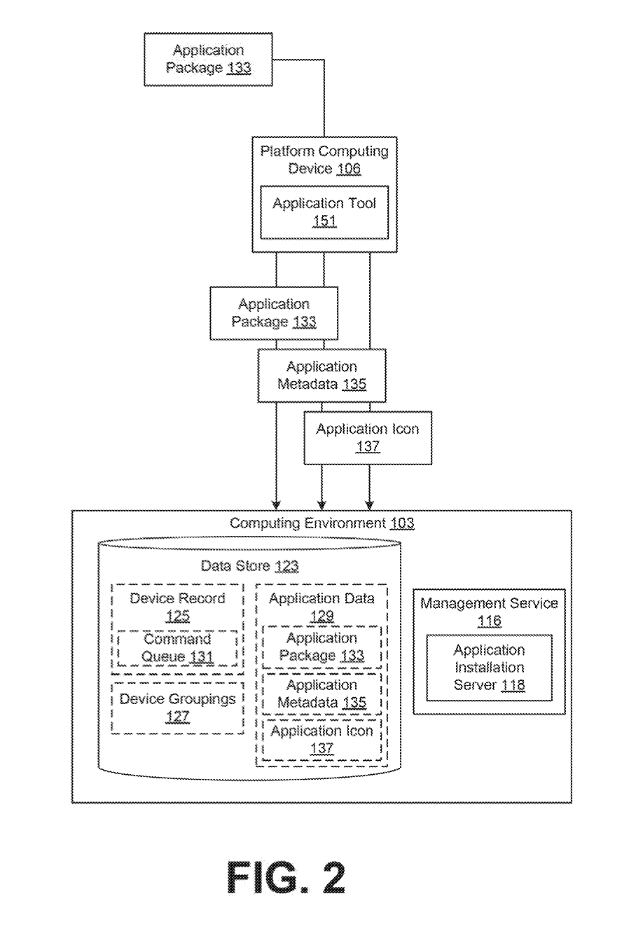

Next, a general description of the operation of the various components of the n worked environment 100 is provided. To facilitate discussion of the disclosure, reference is now made to FIG. 2, which shows the platform computing device 106 and the computing environment 103, which can execute the management service 116. FIG. 2 illustrates how the application tool 151 can provide an application package 133, application metadata 135, and an application icon 137 to the management service 116. The process depicted in FIG. 2 can be performed by an administrator to configure an application for deployment to a macOS client device 109. The process can be a setup process for an application that an administrator deploys to one or more client devices 109 that precedes the uploading of the application package 133 and its associated files to the management service 116.

The application tool 151 can be a utility that can parse an application package 133 to extract the application metadata 135 and application icon 137. The application tool 151, in some cases, might be a third party tool that might be an application that is only compatible with the operating system of the platform computing device 106, such as macOS. Accordingly, the platform computing device 106 might be required in cases where the operating system of the computing environment 103 varies from the client device 109 or platform computing device 106. In some implementations, the platform computing device 106 can be implemented as a virtual machine within the same computing environment 103 in which the management service 116 is executed.

Returning to FIG. 2, the administrator can execute the application tool 151 to parse the application package 133 that he or she wishes to deploy using the management service 116 to obtain the application icon 137 and application metadata 135. The administrator can cause the application tool 151 to extract the application metadata 135 and application icon 137 from the application package 133. In some cases, the administrator can cause the application tool 151 to extract other files or data from the application package 133.

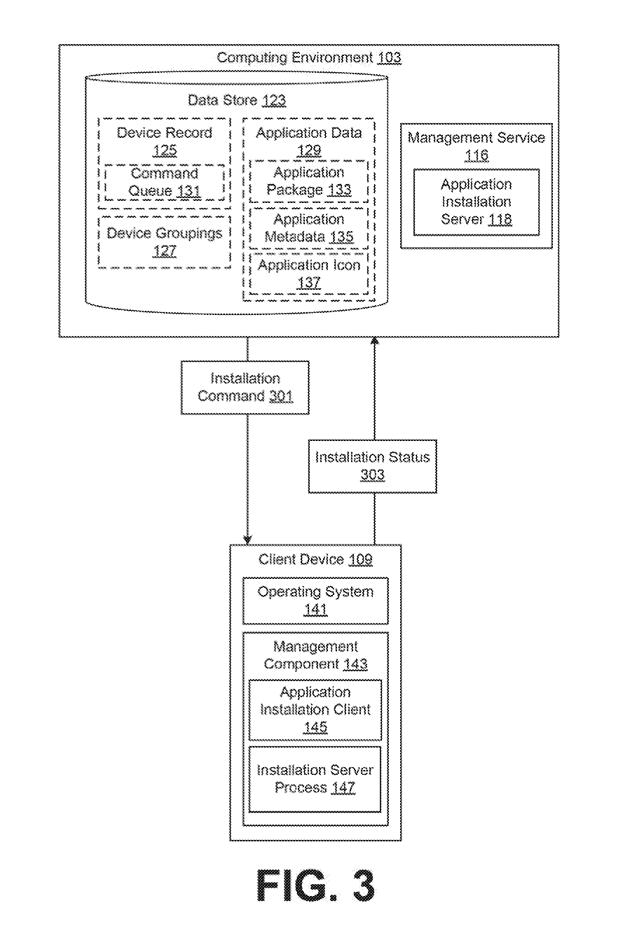

Upon obtaining the extracted files, the administrator can provide the application package 133 and extracted files to the management service 116 through administrative console user interfaces or by using APIs exposed by the management service 116. The administrative console can allow the administrator to configure deployment of an application package 133 to a set of client devices 109 that are enrolled with the management service 116. In one scenario, the administrator can select the application package 133 and a device grouping 127 to which the application package 133 should be deployed. Additionally, the administrator can configure pre-installation or post-installation options, scripts, or programs that should be run by the management component 143 or the application installation client 145 when the application is deployed. Upon configuring the deployment of the application to a device grouping 127 of client devices 109 or to individually selected client devices 109, the management service 116 can place a command in the command queue 131 corresponding to the client devices 109 that causes the application to be deployed. This process is discussed with reference to FIG. 3.

Referring to FIG. 3, the computing environment 103 and a client device 109 that is enrolled with the management service 116 are depicted. As noted above, to cause installation of an application to a client device 109, the management service 116 can issue a command to the management component 143 to install the application. In one scenario, the management service 116 can place an installation command 301 into the command queue 131 of the device record 125 that corresponds to the client device 109. The management component 143 can periodically determine whether commands from the management service 116 have been placed into the command queue 131 and perform the commands.

In other implementations, the management service 116 might have the ability to push commands to a managed client device 109 without requiring the client device 109 to retrieve commands from the command queue 131. In either scenario, the management component 143 can obtain the installation command 301 from the management service 116. The installation command 301 can instruct the management component 143 to install the specified application package 133 onto the client device 109. The installation command 301 can indicate to the management component 143 where or how the application package 133 should be obtained by the management component 143. For example, the installation command 301 can identify a download location of the application package 133, application icons 137, and application metadata 135. The installation command 301 can also indicate pre-installation or post-installation configuration options for the application package 133.

In response to receiving the installation command 301, the management component 143 can obtain the application package 133, the application metadata 135, application icons 137, and other configuration options, files, binaries, or other data associated with the application package 133 as instructed by the installation command 301. The management component 143 can then cause the application installation client 145 to install the application package 133 onto the client device 109 along with any pre-installation, post-installation, or other configuration options specified by the application metadata 135.

The management component 143 can cause the application installation client 145 to install the application package 133 by saving the application package 133 and application metadata 135 to a location on the client device 109 that is accessible to the application installation client 145. The management component 143 can then write a command to a local command queue of the application installation client 145 that instructs the application installation client 145 to install the application package 133 on the client device 109.

In the case of a Munki client, the management component 143 can update a catalog and write to the manifest of the application installation client 145. In this scenario, the manifest is a list of items to install on the client device 109 and can also include a list of tasks that must be performed to complete the installation of an application. The catalog indicates to the Munki client where to find files or items that are referenced by the manifest. The management component 143 can also initiate installation of the application package 133 by sending a command to the application installation client 145 through the installation server process 147 in addition to or instead of updating the catalog or manifest of the application installation client 145.

The application installation client 145 can report on the status of the installation to the installation server process 147. Upon completion of tasks or upon encountering errors, the application installation client 145 can report on its status to the installation server process 147. In some implementations, the management component 143 can obtain the status of an installation from a local database that the application installation client 143 updates when completing installation tasks or upon encountering errors. In turn, the management component 143 can update the management service 116 on the status of an installation with an installation status 303, which can in turn be provided to an administrator through a management console user interface. The installation status 303 can include a status of the execution of post-installation scripts or programs that are associated with the installation of the application in addition to the status of the installation of the application package 133. The installation status 303 can also represent client device conditions such as available disk space, a type of network connection, or other aspects of the client device 109. The installation status 303 can also include the status of pre-installation scripts, prerequisite and dependence application statuses, and installation script, command, or program statuses.

The management component 143 can obtain the status of an installation by extracting installation progress information from a database on the client device 109 that is created by or on behalf of the application installation client 145. In the case of a Munki client, the application installation client 145 can write information about installation tasks to a local database or data store. The management component 143 can access the database to obtain this installation status data.

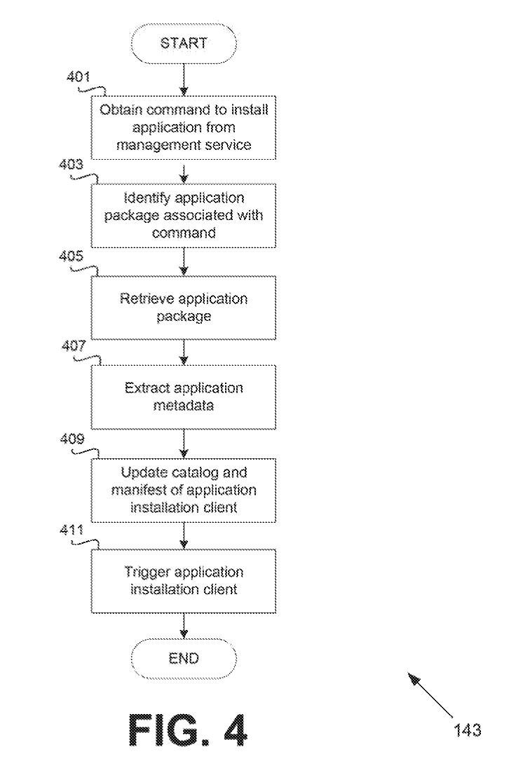

Referring next to FIG. 4, shown is a flowchart that provides an example of how the management component 143 can cause deployment of an application to a managed client device 109 using an application installation client 145 that is installed on the client device 109. The application installation client 145 can be a third party application deployment tool that is separate from the management component 143, such as the Munki client. In some implementations, the Munki client can be packaged along with the management component 143.

First, at step 401, the management component 143 can obtain a command to deploy a particular application to the client device 109. The command can be obtained from the command queue 131 associated with the client device 109. Additionally, communications between the management service 116 and the management component 143 can be secured using encryption and security protocols. The security of communications between the management component 143 and management service 116 provides an improvement over using the application installation client 145 without the management component 143, as the application installation client 145 might not provide security or authentication measures that the management component 143 can provide.

Next, at step 403 the management component 143 can identify the application package 133 being deployed from the command received from or on behalf of the management service 116. The management component 143 can identify the application package 133 by extracting a package name or application identifier from the command.

At step 405, the management component 143 can retrieve the application package 133 identified by the command. The management component 143 can download the application package 133, which can include the installer or application binary, the application metadata 135, and other files or data associated with the application by downloading the files from the management service 114 or a location specified by the command.

At step 407, the management component 143 can extract the application metadata 135 from the data that was downloaded at step 405. In some cases, the application metadata 135 can be a separate file that is obtained alongside the application package 133. The application metadata 135 can include information that specifies the installation and configuration options for the deployment of the application.

At step 409, the management component 143 can update the manifest and catalog associated with the application installation client 145. In the case of a Munki client as the application installation client 145, the manifest is a list of items to install on the client device 109 and can also include a list of tasks that must be performed to complete the installation of an application. The catalog indicates to a Munki client, for example, where to find files or items that are referenced by the manifest. The management component 143 can also initiate installation of the application package 133 by sending a command to the application installation client 145 through the installation server process 147 in addition to or instead of updating the catalog or manifest of the application installation client 145.

At step 411, the management component 143 can trigger the installation of the application by the application installation client 145. The application installation client 145 can be triggered via a command from the installation server process 147 or in response to the management component 143 updating the manifest or catalog of the application installation client 145. Thereafter, the process proceeds to completion.

The flowchart of FIG. 4 shows an example of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of some code that includes human-readable statements written in a programming language, or machine code that includes machine instructions recognizable by a suitable execution system, such as a processor in a computer system or other system. If embodied in hardware, each element can represent a circuit or a number of interconnected circuits that implement the specified logical function(s).

Although the flowchart of FIG. 4 shows a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages might be added to the logical flow described herein, for purposes of enhanced utility, accounting, performance measurement, or troubleshooting aid. It is understood that all such variations are within the scope of the present disclosure.

The computing environment 103, the client device 109, or other components described herein can each include at least one processing circuit. Such a processing circuit can include one or more processors and one or more storage devices that are coupled to a local interface. The local interface can include a data bus with an accompanying address/control bus or any other suitable bus structure.

The one or more storage devices for a processing circuit can store data or components that are executable by the one or processors of the processing circuit. The management service 116 or other components can be stored in one or more storage devices and be executable by one or more processors. Also, a data store, such as the data store 123, can be stored in the one or more storage devices.

The management service 116 and other components described herein can be embodied in the form of hardware, as software components that are executable by hardware, or as a combination of software and hardware. If embodied as hardware, the components described herein can be implemented as a circuit or state machine that employs any suitable hardware technology. Such hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

What is claimed is:

1. A system for deploying an application to a managed device enrolled with a management service, comprising:
a client device comprising a processor and a memory; and
a management component stored in the memos that, when executed by the processor, causes the client device to at least:
obtain an application package identified by the management service, the application package comprising an application for installation on the client device, wherein the management service sends the application package to the client device based upon an assignment of the application package to a grouping of client device that includes the client device;
generate a command to cause installation of the application on the client device;
provide the command to cause installation of the application to an application installation client;
query the application installation client for a status of the installation of the application; and
transmit the status of the installation of the application the management service.

2. The system of claim 1, wherein the application installation client is a separate application from the management component.

3. The system of claim 1, wherein the management component obtains the application package by receiving a command to retrieve the application package from a command queue, wherein the management service writes the command to retrieve the application package to the command queue.

4. The system of claim 1, wherein the status of the installation of the implication further comprises a status of post-installation scripts associated with the installation of the application.

5. The system of claim 1, wherein the management component provides the application installation client by writing to a manifest and a catalog associated with the application installation client.

6. The system of claim 1, wherein the management component executes a server process that acts as proxy server on behalf of the application installation client to obtain the application package identified by the management service.

7. The system of claim 1, wherein the application package is formatted in an Apple package format or a disk image format.

8. A method for deploying an application to a managed device enrolled with a management service, comprising:
obtaining, in a management component installed on a client device, an application package identified by the management service, the application package comprising an application for installation on the client device, wherein the management service sends the application package to the client device based upon an assignment of the application package to a grouping of client device that includes the client device;
generating, in the management component, a command to cause installation of the application on the client device;
providing, by management component, the command to cause installation of the application to an application installation client;
querying, by the management component, the application installation client for a status of the installation of the application; and
transmitting, from the management component, the status of the installation of the application the management service.

9. The method of claim 8, wherein the application installation client is a separate application from the management component.

10. The method of claim 8, wherein obtaining the application package further comprises receiving a command to retrieve the application package from a command queue, wherein the management service writes the command to retrieve the application package to the command queue.

11. The method of claim 8, wherein the status of the installation of the application further comprises a status of post-installation scripts associated with the installation of the application.

12. The method of claim 8, further comprising providing, by the management component, the command to cause installation of the application to the application installation client by writing to a manifest and a catalog associated with the application installation client.

13. The method of claim 8, further comprising executing a server process that acts as proxy server on behalf of the application installation client to obtain the application package identified by the management service.

14. The method of claim 8, wherein the application package is formatted in an Apple package format or a disk image format.

15. A non-transitory computer-readable medium embodying a program executable on a client device, the program facilitating deployment of an application to the client, device enrolled with a management service, the program causing the client device to at least:
obtain an application package identified by the management service, the application package comprising an application for installation on the client device, wherein the management service sends the application package to the client device based upon an assignment of the application package to a grouping of client device that includes the client device;
generate a command to cause installation of the application on the client device;
provide the command to cause installation of the application to an application installation client;
query the application installation client for a status of the installation of the application; and
transmit the status of the installation of the application the management service.

16. The non-transitory computer-readable medium of claim 15, wherein the program causes the client device to obtain the application package by receiving a command to retrieve the application package from a command queue, wherein the management service writes the command to retrieve the application package to the command queue.

17. The non-transitory computer-readable medium of claim 15, wherein the status of the installation of the application further comprises a status of post-installation scripts associated with the installation of the application.

18. The non-transitory computer-readable medium of claim 15, wherein the program causes the client device to provide the command to cause installation of the application to an application installation client by writing to a manifest and a catalog associated with the application installation client.

19. The non-transitory computer-readable medium of claim 15, wherein the program causes the client device to execute a server process that acts as proxy server on behalf of the application installation client to obtain the application package identified by the management service.

20. The non-transitory computer-readable medium of claim 15, wherein the application package is formatted in an Apple package format or a disk image format.
